(19) United States
(12) Patent Application Publication
(10) Pub. No.: US 2016/0183501 A1
(43) Pub. Date: Jun. 30, 2016

(54) AQUACULTURE CONTAINMENT PEN

(71) Applicant: Ocean Farm Technologies, Inc., Morill, ME (US)

(72) Inventor: Stephen H. PAGE, Searsmont, ME (US)

(21) Appl. No.: 14/852,833

(22) Filed: Sep. 14, 2015

Related U.S. Application Data
(63) Continuation of application No. PCT/US2014/025275, filed on Mar. 13, 2014.
(60) Provisional application No. 61/781,096, filed on Mar. 14, 2013.

(51) Int. Cl. A01K 61/00

(52) U.S. Cl. CPC A01K 61/007

(57) ABSTRACT

In some embodiments, an apparatus for aquaculture includes a support structure defining an interior region. The support structure includes a first support member disposed in a first plane, a second support member disposed in a second plane orthogonal to the first plane, and a third support member disposed in a third plane orthogonal to the first plane and the second plane. A mesh material is disposed in the interior region of the apparatus and is coupleable to the support structure. The mesh material defines a containment volume suitable for cultivating aquatic organisms. A plurality of tensioning members are configured and disposed to couple the mesh material to the support structure. Each of the tensioning members are coupled to the mesh material and at least one of the first, the second and the third support member, and configured to provide tensile loading on the first, second and third support members.

### CROSS-REFERENCE TO RELATED APPLICATIONS

This application claims priority to and the benefit of U.S. Provisional Patent Application No. 61/781,096, entitled “Aquaculture Containment Pen,” filed Mar. 14, 2013, the disclosure of which is incorporated herein by reference in its entirety.

### BACKGROUND

Embodiments described herein relate generally to devices, systems and methods for cultivating aquatic organisms, and more particularly to containment pens for use in cultivating aquatic organisms.

Finfish aquaculture and other marine life aquaculture typically utilize ponds or net pens to contain aquatic organisms. A typical net pen used in open water generally consists of a net suspended from a structure (e.g., a circular plastic collar) floating on the surface of the water. The walls of the net extend vertically from the water's surface to a depth of typically 6 to 20 meters, and then across the bottom to form the containment pen.

The nets used in these conventional containment pens are quite large. When they are dry they can weigh several tons and at the end of a growing cycle they can weigh 20 tons or more owing to the fouling from marine organisms such as algae and mussels. There is no practical way to clean these nets underwater, and handling of these large nets for repair and maintenance presents numerous logistical and economic challenges for aquaculture operators. Furthermore, ocean currents and wave action can cause deformation of the suspended nets, which can result in pockets where predators such as sharks and seals can push in to bite fish and/or tear the net. To prevent predator attacks and damage to the containment net, a heavier and coarser secondary predator net is often used to entirely encapsulate the containment net. The predator net is typically suspended from the outside of the floating circular collar, and the containment net is suspended from the inside of the collar. A third net is sometimes strung above the surface of the containment pens to prevent predator birds (e.g., osprey, eagles, heron, gulls, etc.) from accessing to the pens from the air.

Thus, there is a need for new aquaculture containment pens that can overcome the limitations of conventional suspended net containment pens and offer greater location flexibility (e.g., farther offshore), are resistant to predation, are easy to clean at the surface and are easily maneuverable and transportable for operation and maintenance, yet remain cost competitive with the conventional suspended net containment pens.

### SUMMARY

Embodiments described herein relate generally to devices, systems and methods for cultivating aquatic organisms in a containment pen. In some embodiments, an apparatus includes a support structure defining an interior region. The support structure includes a first support member disposed in a first plane, a second support member disposed in a second plane orthogonal to the first plane, and a third support member disposed in a third plane orthogonal to the first plane and the second plane. A mesh material is disposed in the interior region of the apparatus and is coupleable to the support structure. The mesh material is configured to define a containment volume suitable for cultivating aquatic organisms. A plurality of tensioning members are configured and disposed to couple the mesh material to the support structure. Each of the plurality of tensioning members are coupled to or integral to the mesh material and at least one of the first support member, the second support member and the third support member. The tensioning members are also configured to provide tensile loading on the first, second and third support members.

### BRIEF DESCRIPTION OF THE DRAWINGS

FIG. 1 is a schematic block diagram of an aquaculture containment pen, according to an embodiment.

FIG. 2 is a perspective view of an aquaculture containment pen, according to an embodiment.

FIG. 3 is a perspective view of a support structure included in FIG. 2 moored in a four point configuration, according to an embodiment.

FIG. 4 is a perspective view of a support structure of the containment pen of FIG. 2 in a first configuration.

FIG. 5 is a perspective view of the support structure of the containment pen of FIG. 2 in a second configuration.

FIG. 6 is a side view of a coupling mechanism according to an embodiment, in a first configuration.

FIG. 7 is a cross-section view of the coupling mechanism of FIG. 6 taken along line 7-7.

FIG. 8 is a side view of the coupling mechanism of FIG. 6, in a second configuration.

FIG. 9 shows a perspective view of a support structure for an aquaculture containment pen, according to an embodiment.

FIG. 10 shows an enlarged view of a connector included in the aquaculture containment pen of FIG. 9, according to an embodiment.

FIGS. 11-12 show results of a Finite Element Analysis (FEA) performed on an embodiment of a containment pen.

### DETAILED DESCRIPTION

Aquaculture operations (also referred to herein as “aquafarming” or “fish farming”) that utilize conventional containment pens (e.g., suspended net systems) for cultivating aquatic organisms are generally located near shore, where sea conditions (e.g., wave action, wind, and ocean currents) are less severe, and access is easier for operation and maintenance. However, offshore locations are known to have numerous advantages. For example, in offshore locations, water depths are usually greater, thus the containment pens can be submerged during storm conditions when fish would naturally move to greater depths to avoid damage from wave action. Water quality is generally better, as there is less pollution from land sources and greater water circulation (e.g., stronger currents) through the pens helps dilute waste nutrients from the organisms being cultivated. Furthermore, water temperatures are more stable and the risk of disease is reduced due to increased distance between farms. Finally, the general public is typically opposed to any structures at the surface of the ocean that are visible from shore, so moving the aquaculture operations further offshore reduces the visual impact of aquaculture, and thus decreases political opposition.

Conventional suspended net containment pens are not suitable for offshore aquaculture for a number of reasons including, for example: 1) the support structure used to suspend the nets are not stable in the offshore environment, 2) the suspended nets do not have any structural support, therefore ocean currents and wave action can deform the suspended nets, thus reducing the containment volume and/or damaging the net, and/or causing stress on the cultivated organisms and 3) the suspended nets are generally only suitable for containing the aquatic organisms and are not predator proof so additional predator resistant nets have to be used, which makes the maintenance of the conventional containment pens cumbersome as well as increases the overall cost of the containment pen, and 4) no practical method for cleaning these nets in offshore conditions has been demonstrated.

Embodiments of the devices, systems and methods described herein for cultivating aquatic organisms are suitable for offshore deployment and offer several advantages over conventional suspended net containment pens including, for example: 1) the support structure of the containment pen is lightweight and can easily be transported to an offshore location in an unassembled configuration and assembled on-site; 2) the support structure can also be assembled onshore and then transported to an offshore location in an assembled configuration; 3) the support structure can be assembled onshore and then manipulated into a collapsed configuration by a simple reorientation of the support members so that the collapsed structure can be easily transported to the offshore location and then urged into an expanded configuration for deployment; 4) the mesh material (also referred to herein as “containment net”) can be coupled to the support structure onshore during assembly or at the offshore location; 5) the mesh material is made from a predator resistant material, therefore only a single containment net is needed for containing the aquatic organism as well as protecting the aquatic life forms from predators; 6) the tensioning members used to couple the mesh material to the support structure are also configured to impart structural integrity to the support structure; and 7) the containment pen can be configured to be coupleable to a four-point mooring, which is the current industry standard for securing containment pens deployed at off shore locations, and allows for easier maintenance of the containment pen because it can be rotated about a mooring axis so that any face of the containment pen can be brought to the surface for cleaning and inspection.

In some embodiments, a containment pen includes a support structure that defines an interior region. The support structure includes a first support member disposed in a first plane, a second support member disposed in a second plane orthogonal to the first plane, and a third support member disposed in a third plane orthogonal to the first plane and the second plane. A mesh material is disposed in the interior region of the apparatus and is coupleable to the support structure. The mesh material is configured to define a containment volume suitable for cultivating aquatic organisms. A plurality of tensioning members are configured and disposed to couple the mesh material to the support structure. Each of the plurality of tensioning members are coupled to the mesh material and at least one of the first support member, the second support member and the third support member. The tensioning members are also configured to provide tensile loading on the first, second and third support members.

In some embodiments, the tensioning members may be integral to the mesh material. In some embodiments, an aquaculture containment pen includes a support structure having a first ring member, a second ring member and a third ring member. Each of the first, second and third ring members are configured and disposed substantially orthogonal to the other two ring members. A containment net coupled to the support structure defines a containment volume suitable for cultivating aquatic organisms. The containment net includes a plurality of tensioning members configured and disposed to couple the containment net to the support structure and provide tensile loading on the first, second and third ring members.

In some embodiments, an aquaculture containment pen includes a support structure having a first ring member movably coupled to a second ring member, and a third ring member movably coupled to the second ring member. The support structure is movable between a first configuration such that the first, second and third ring members are substantially coplanar, and a second configuration such that each of the first, second and third ring members are substantially orthogonal to the other two ring members. A containment net coupled to the support structure defines a containment volume suitable for cultivating aquatic organisms.

As used herein, the term “about” and “approximately” generally mean plus or minus 10% of the value stated, e.g., about 100 m would include 90 m to 110 m.

As used herein, the term “set” can refer to multiple features or a singular feature with multiple parts. For example, when referring to set of support members, the set of support members can be considered as one support member with distinct portions, or the set of support members can be considered as multiple support members. Similarly stated, a monolithically constructed item can include a set of support members. Such a set of support members can include, for example, multiple portions that are in discontinuous from each other. A set of support members can also be fabricated from multiple items that are produced separately and are later joined together (e.g., via a weld, an adhesive or any suitable method).

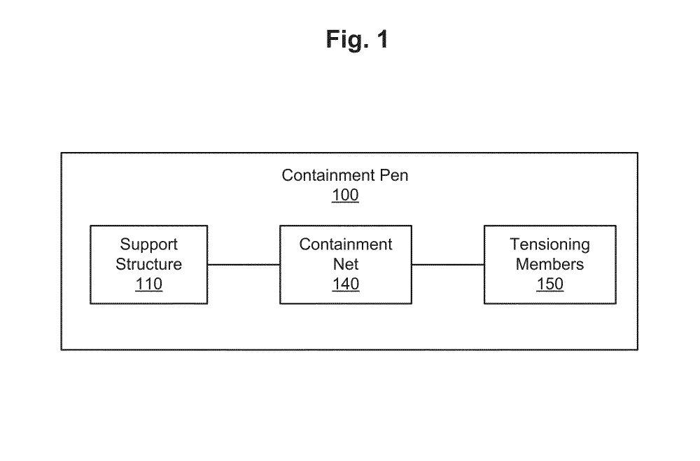

FIG. 1 shows a schematic block diagram of a containment pen 100 for cultivating aquatic organisms (also referred to herein as an “aquaculture containment pen”). The containment pen 100 includes a support structure 110, a containment net 140 and a set of tensioning members 150. In some embodiments, the containment net 140 can be removably coupled to the support structure 110. In some embodiments, the tensioning members 150 can be configured to removably couple the containment net 140 to the support structure 110.

The support structure 110 can define an interior volume, for example, for disposing the containment net 140. In some embodiments, the support structure 110 can include a set of support members (not shown) that can be coupled to each other to form the support structure 110. In some embodiments, the support structure 110 can include two support members, three support members, four support members, five support members, or even more support members. In some embodiments, the support structure 110 can include a first support member, a second support member and a third support member. The first support member can be disposed in a first plane, the second support member can be disposed in a second plane orthogonal to the first plane, and the third support member can be disposed in a third plane orthogonal to the first plane and the second plane. The first, second and third support members when coupled together, form the support structure 110 that has a substantially spherical shape. In some embodiments, the support structure 110 can have a diameter in the range of about 80 to 120 feet.

In some embodiments, the support structure 110 includes a first support member that is movably coupled to a second support member, and the second support member that is movably coupled to a third support member. The support structure 110 (i.e., the first, second and third support members) can be moved between a first configuration, such that each of the first, second and third support members are substantially coplanar and a second configuration such that each of the first, second and third support members are substantially orthogonal to the other two support members.

In some embodiments, the first, second and third support members are coupled to each other at locations that are defined as vertices of an octahedron. In some embodiments, a first coupling mechanism (not shown) can be used to couple the first support member to the second support member, and a second coupling mechanism (not shown) can be used to couple the second support member to the third support member. The first coupling mechanism can be substantially the same as the second coupling mechanism. In some embodiments, the first and/or second coupling mechanism can include, for example, clamps, ropes, wires, bolts, rivets, screws, any other suitable coupling mechanism or combination thereof. In some embodiments, the support structure 110 is configured to be coupleable to a four-point mooring. In some embodiments, the coupling mechanism serves as attachment points for coupling the support structure 110 to a four-point mooring.

In some embodiments, the support members can be substantially circular (e.g., rings) and can have a substantially circular cross section such as, for example, pipes. The pipes used to form the support member can be hollow and can include apertures to allow a lumen defined by the support member to be filled with a liquid (e.g., water) or a gas (e.g., air) to modify the buoyancy of the support structure 110. For example, the support members can be filled with water to submerge the support structure 110 or filled with air to raise the support structure to the surface. In some embodiments, the support members can be made from a material that is light weight, rigid, strong resistant to rusting, and can have a substantially neutral buoyancy such that the support structure 110 has a specific gravity in the range of about 0.94 to about 1. For example, the support member can be made from high density polyethylene. In some embodiments, the support members can be made of materials that have a specific gravity greater than one, which achieve neutral buoyancy by means of air-filled cavities, for example steel, aluminum, or fiberglass. In some embodiments, the support members and/or other portions of the support structure 110 can include flotation members (e.g., foam structures), weights, or ballast tanks to selectively modify the specific gravity of the containment pen 100. In some embodiments, the support structure 110 can have any other shape such as, for example, a square, an ellipsoid, or any other suitable shape/structure or combination thereof.

The containment net 140 can include a mesh material configured to be reversibly coupleable to the support structure 110. For example, the containment net 140 can be inscribed in an interior region defined by the support structure 110. The containment net 140 can be configured to define an internal volume suitable for containing and cultivating aquatic organisms. In some embodiments, the containment volume defined by the containment net 140 can be substantially spherical. In some embodiments, the containment volume defined by the containment net 140 can have a substantially geodesic structure such as, for example, an icosahedron or an octahedron. The geodesic structure of the containment net 140 can be configured to be coupleable to a four-point mooring. In some embodiments, the containment net 140 can be made from a substantially predator resistant material such as, for example, polyethylene fiber, stainless steel, Dyneema®, any other predator resistant material or combination thereof.

As described herein, the tensioning members 150 can be configured to removably couple the containment net 140 to the support structure 110. The tensioning members 150 can be disposed in and/or otherwise coupled to the containment net 140, e.g., weaved, welded, glued, tied, or attached to the containment net 140 using any other suitable mechanism. In some embodiments, the tensioning members 150 can be integral with the containment net 140. In some embodiments, the tensioning members 140 can be configured to urge the containment net 140 into the shape of a geodesic structure. For example, the tensioning members 150 can intersect each other to form a multitude of polygons, e.g. triangles, such that the plurality of polygons form the faces of the geodesic structure. In some embodiments, the tensioning members 150 can be formed from a strong, but flexible material such as, for example, metal wire, Dyneema, metal ropes, fiber ropes, any other strong predator resistant material or combination thereof.

In some embodiments, each of the set of tensioning members 150 can be coupled to at least one of the first support member, the second support member and the third support member of the support structure 110. In some embodiment, the tensioning members 150 can be coupled to the support structure 100 at predetermined discrete locations. In some embodiments, the predetermined locations can be vertices of a geodesic structure, i.e., the geodesic structure formed by the containment net 140. In some embodiments, the tensioning members 150 can be configured to exert a compressive force on the support structure 110 such that the combination of the tension in the tensioning members 150 and compression in the support structure 150 provides structural integrity to the containment pen 100. In some embodiments, the sum of the forces applied by the tensioning members 150 to the support members is approximately 0. In some embodiments, the containment net 140 can be coupled continuously to the support members. Said another way, the containment net 140 can be coupled along the entire length of the support members. In such embodiments, the containment net 140 can be coupled to the support members using a slot coupling mechanism, laces, threads, zippers, any other suitable coupling mechanism or combination thereof. In this manner, the internal volume of the containment net 140 can be maximized. Furthermore, any load concentration due to coupling at discrete locations, can also be minimized.

In some embodiments, the tensioning members 150 are configured to stabilize the support structure 110 of the containment pen 100. For example, the structural integrity imparted by the tensioning members 140 to the support structure 110 can allow the containment pen 100 to withstand currents of at least 3 knots, or even greater when deployed in the open ocean.

Having described above various general principles, several exemplary embodiments of these concepts are now described. These embodiments are only examples, and many other configurations of an aquaculture containment pen for cultivating aquatic organisms are contemplated.

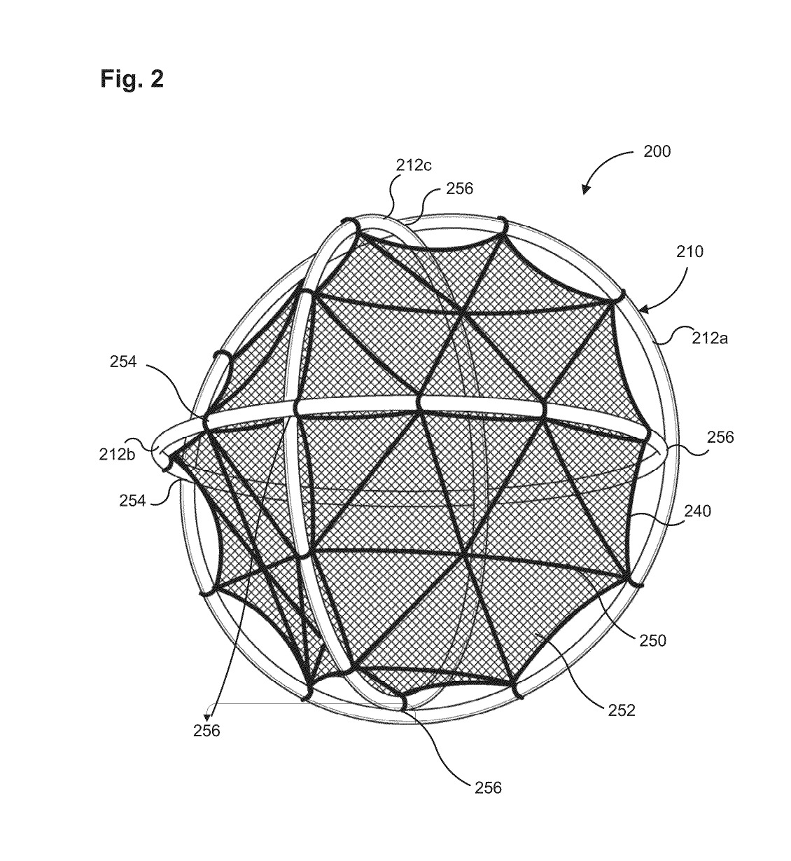

Referring now to FIG. 2, a containment pen 200 for cultivating aquatic organisms includes a support structure 210, a containment net 240 and a set of tensioning members 250. The tensioning members 250 are disposed in, and/or otherwise coupled to the containment net 240, and are configured to reversibly couple the containment net 240 to the support structure 210.

As shown, the support structure 210 includes a first support member 212a, a second support member 212b and a third support member 212c (collectively referred to as 212) that are movably coupled to each other to form the support structure 210. The support members 212 are substantially circular rings made from a tubular material. In some embodiments, each of the support members 212 can be formed of a series of distinct pieces that can be joined together, e.g., screwed, glued, hot welded, snap fitted, or joined through any other suitable mechanism, to form the support member 212.

The support members 212 are configured such that the first support member 212a has a diameter slightly larger than the second support member 212b, and the second support member 212b has a diameter slightly larger than the third support member 212c. Therefore the second support member 212b can be disposed substantially within the first support member 212a, and the third support member 212c can be disposed substantially within the second support member 212b, such that the support members 212 resemble concentric rings. In some embodiments, the diameter of the support members 212 can be in the range of about 80 to 120 feet. In some embodiments, the outside diameter of the material used to make the support members 212 (e.g., the pipes) can be about 12 to about 20 inches. In some embodiments, the support members 212 can be hollow and can have a wall thickness of about 1.5 to about 2 inches.

As shown in FIG. 2, the first support member 212a is disposed in a first plane and the second support member 212b is disposed in a second plane, such that the second plane is orthogonal to the first plane. The third support member 212c is disposed in a third plane such that the third plane is orthogonal to the first plane and the second plane.

The containment net 240 is configured to be reversibly coupleable to the support structure 210. For example, the containment net 240 can be inscribed in an interior region defined by the support structure 210. The containment net 240 is made from a mesh material that can be formed from a substantially predator resistant material such as, for example, polyethylene fiber, stainless steel, DYNEEMA®, metallic alloy mesh, or any other predator resistant material or combination thereof. The containment net 240 is configured to define an internal volume suitable for containing and cultivating aquatic organisms. In some embodiments, a mesh material, for example, a predator net can be disposed outside the support structure 210 such that the support structure 210 is surrounded by the mesh material. In such embodiments, the mesh material can, for example, provide a second layer of protection to the aquatic organisms (e.g., fish) disposed within the internal volume defined by the containment pen 240 against predators. In some embodiments, the containment net 240 can be coupled to the outside surface of the support structure 210, such that the support structures 210 is disposed within the internal volume defined by the containment pen 240.

The tensioning members 250 are configured to removably couple the containment net 240 to the support structure 210. The tensioning members 250 can be disposed in and/or otherwise coupled to the containment net 240, e.g., weaved, welded, glued, tied, or attached to the containment net 240 using any other suitable mechanism. In some embodiments, the tensioning members 250 can be integral with the containment net 240, for example, monolithically formed with the containment net 240. In some embodiments, the tensioning members 240 can be configured to urge the containment net 240 into the shape of a geodesic structure. In such embodiments, the tensioning members 250 can intersect each other to form a plurality of triangles 252, such that the pluralities of triangles 252 form the faces of the geodesic structure defined by the containment net 240.

Each of the tensioning members 250 is coupled to at least one of the support members 212 (e.g., support member 212a, 212b or 212c). In some embodiments, at least a portion of the tensioning members 250 are coupled to two or more of the support members 212. In some embodiments, the tensioning members 250 are coupled to the support structure 210 at predetermined discrete locations 254. For example, the predetermined locations 254 can be vertices of a geodesic structure, i.e., the geodesic structure formed by the containment net 240.

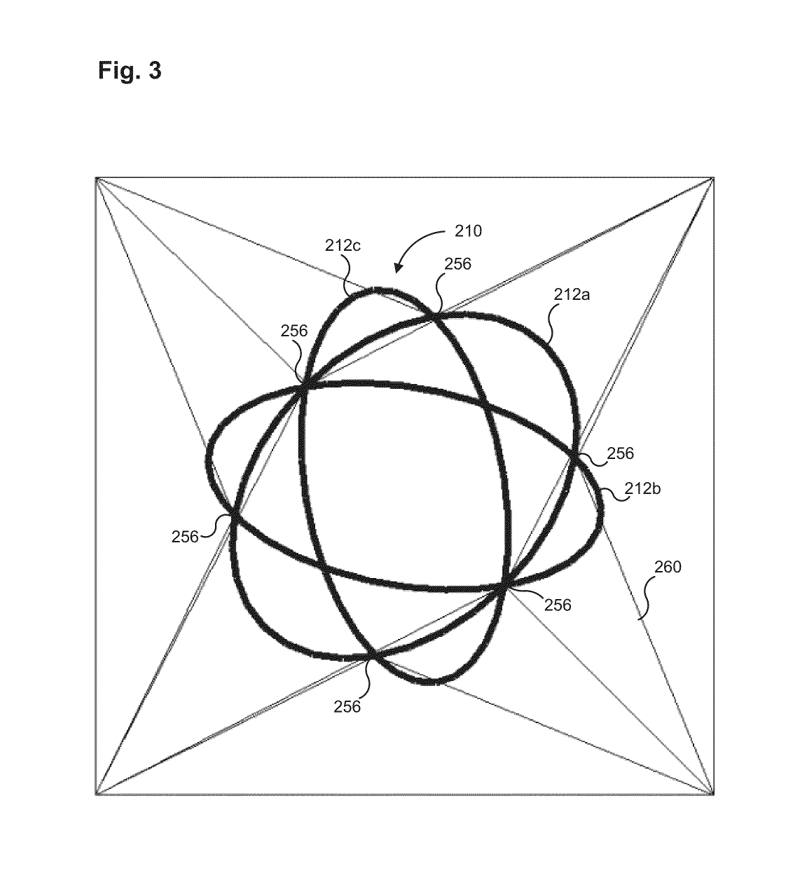

In some embodiments, the containment pen 200 or any other containment pen described herein can be moored in a four point mooring configuration. For example, FIG. 3 shows the support structure 210 of the containment pen 200 moored by mooring line 260 in a four point mooring configuration. The containment net 240 is not shown for clarity. Each mooring line 260 can be coupled to the support structure 210, for example, at intersecting points 256 where the support members 212 intersect each other. The four point mooring shown in FIG. 3 is the current industry standard for securing containment pens deployed at offshore sites. Four point mooring can allow easy rotation of the containment pen 200, or any other containment pen described herein about a mooring axis so that any face of the containment pen 200 can be brought to the surface of the water for cleaning and/or inspection.

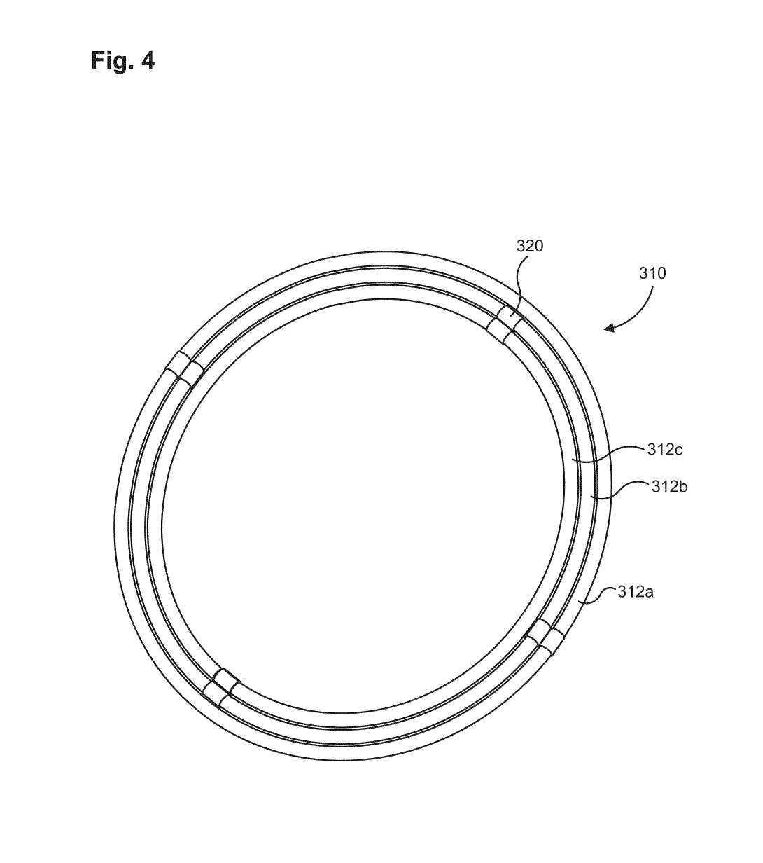

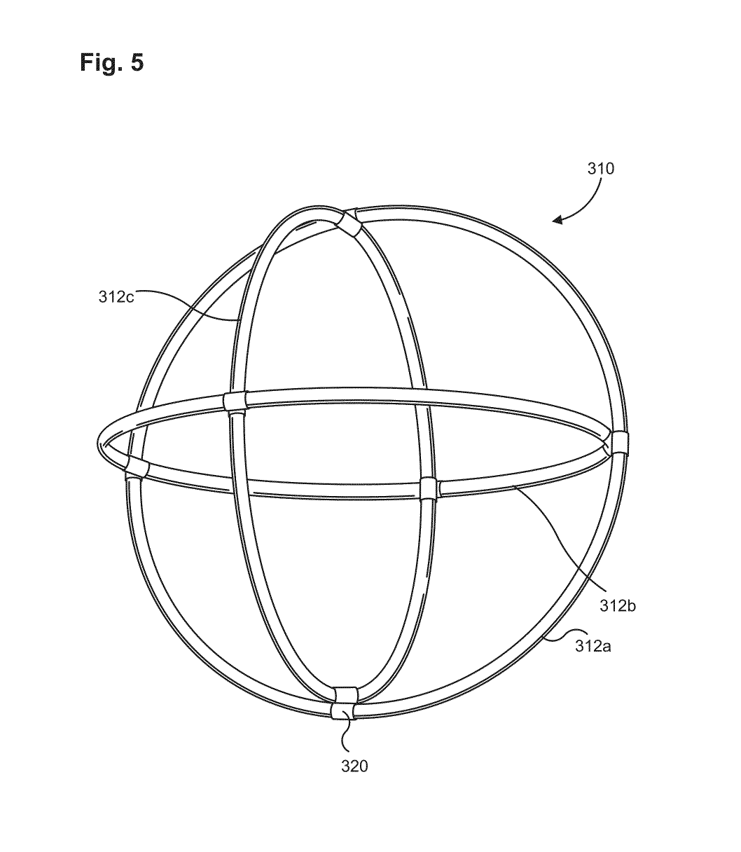

Referring now to FIG. 4 and FIG. 5, a containment pen for cultivating aquatic organisms includes a support structure 310 having a first support member 312a, a second support member 312b and a third support member 312c (collectively referred to as “the support members 312”) movably coupled to each other. For example, the first support member 312a can be movably coupled to the second support member 312b, and second support member 312b can be movably coupled to the third support member 312c such that the support structure 310 can be moved between a first collapsed configuration (FIG. 4) such that the support members 312 are substantially coplanar, and a second expanded configuration (FIG. 5) such that the support members 312 are substantially orthogonal to each other. The support members 312 can, for example, be coupled to each other using coupling mechanisms 320 or any other suitable mechanism. In some embodiments, the support members 312 can be coupled to each other at locations that define the vertices of an octahedron.

In some embodiments, the support structure 310 can be assembled in the collapsed configuration onshore and delivered to the offshore deployment location in the collapsed configuration. Once at the deployment location, the support structure 310 can be manipulated into the expanded configuration and deployed. In some embodiments, the support structure can be assembled in the expanded configuration onshore, collapsed for transportation (onshore or offshore), and then moved to the expanded configuration. In some embodiments, the support structure can be moved to the collapsed configuration for cleaning, maintenance, and/or transportation to a new location.

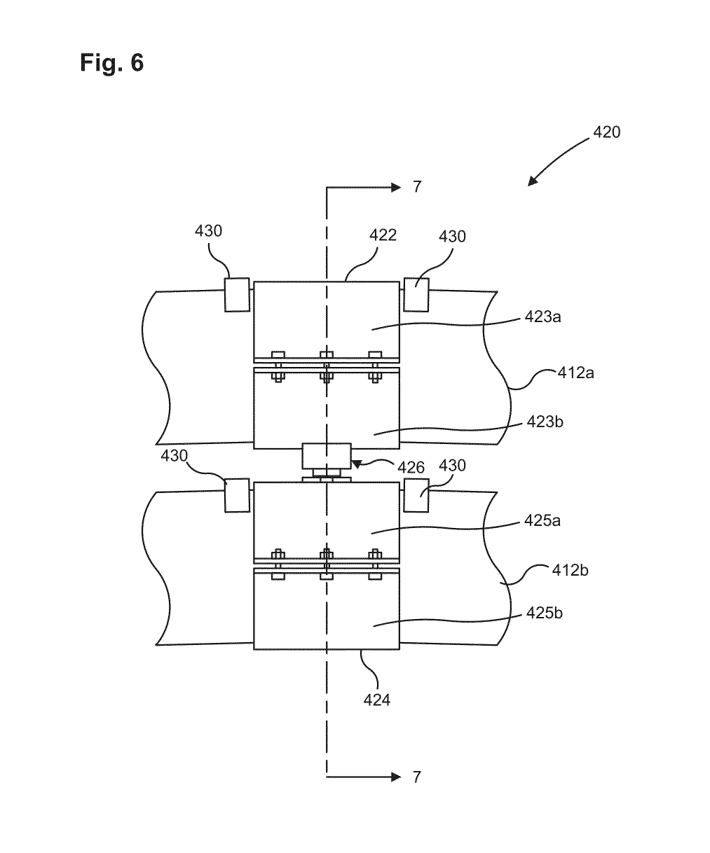

In some embodiments, a coupling mechanism can be used to couple the support members of a support structure to each other. Referring now to FIGS. 6-8, in some embodiments, a coupling mechanism 420 that can be included in a support structure, e.g., support structure 110, 210, 310 or any other support structure described herein, can include a first coupling member 422 and a second coupling member 424. The first coupling member 422 and second coupling member 424 can be used to couple a first support member 412a to a second support member 412b. Additional coupling mechanisms 420 can be used to couple the second support member 412b to a third support member (not shown) as described herein.

FIG. 6 shows a side view of the coupling mechanism 420 used for coupling the first support member 412a to the second support member 412b, in a first configuration such that the first support member 412a and the second support member 412b are substantially coplanar. The coupling member 422 includes a first portion 423a that is removably coupleable to a second portion 423b such that the support member 412a can be tightly clamped, secured and/or gripped between the first portion 423a and the second portion 423b. The first portion 423a of the coupling member 422 can be reversibly coupled to the second portion 423b using bolts, rivets, screws, latch, spring latch, snap fit, or any other suitable coupling means. In some embodiments, the first portion 423a of the coupling member 422 can be pivotally coupled to the second portion 423b, such that the first portion 423a can move from a first configuration, such that the support member 412a can be uncoupled from the coupling mechanism 420, to a second configuration, wherein the support member 412a is secured to the coupling mechanism 420. Similarly, the coupling member 424 includes a first portion 425a that is removably coupleable to a second portion 425b such that the support member 412b can be tightly clamped, secured and/or gripped between the first portion 425a and the second portion 425b.

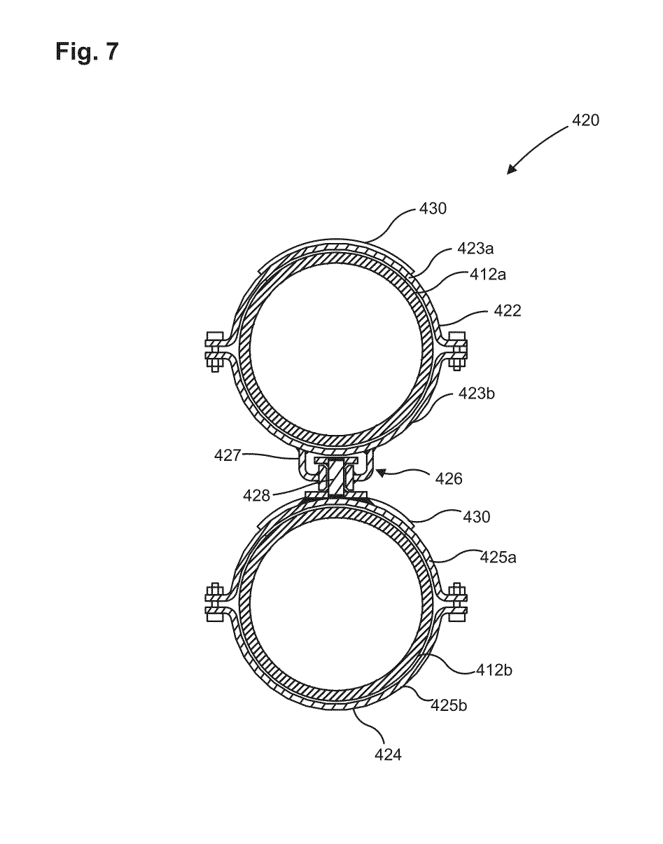

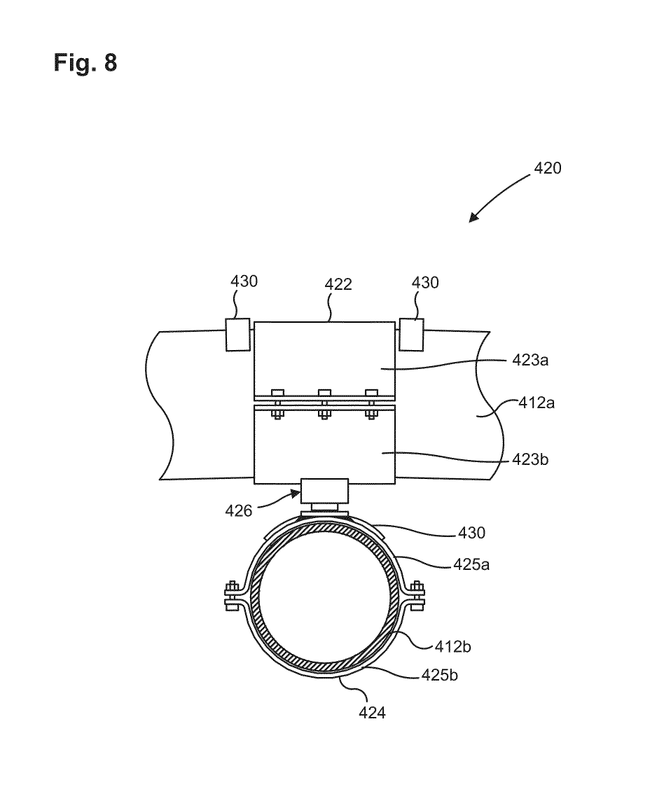

In some embodiments, the first coupling member 422 can be movably coupled to the second coupling member 424 using a swivel mechanism 426. FIG. 7 shows a cross-section of the coupling mechanism 420 taken along the line 7-7 as shown in FIG. 6. The swivel mechanism 426 includes a swivel mount 427 mounted on a mandrel 428 such that the swivel mount 427 can rotate about the mandrel 428. The swivel mechanism 426 can allow the coupling member 424 and the second support member 412b clamped therein to rotate from a first configuration (FIG. 6, FIG. 7) such that the first support member 412a and the second support member 412b are substantially coplanar, to a second configuration as shown in FIG. 8 such that the second support member 412b is substantially orthogonal to the first support member 412a. In some embodiments, the coupling mechanism 420 can include a locking mechanism (not shown) to lock the coupling mechanism 420, and therefore the support members 412, in the first configuration and/or the second configuration. For example, the coupling mechanism 420 can include a spring latch, hole and key lock, ratchet lock, or any other suitable locking mechanism. In such embodiments, the coupling mechanism 420 can also include a release mechanism to release the locking mechanism.

In some embodiments, the support members 412a and 412b, can include stoppers 430, for example, to prevent coupling the mechanism 420 from sliding along the length of the support members 412a and 412b. In some embodiments, the stopper 430 can be an integral part of the support members 412a and 412b, e.g., formed in a single manufacturing process. In some embodiments, the stopper 430 can be a separate member that is disposed on and coupled to the support members 412a and 412b by e.g., clamp fitting, gluing, hot welding, screwing, bolting, riveting, or any other suitable mechanism. In some embodiments, the support members 412a and 412b can include recesses sized and shaped to receive the coupling mechanism 420, such that the coupling members 422 and 424 can be seated within the recess and prevented from moving laterally by the sidewalls of the recess.

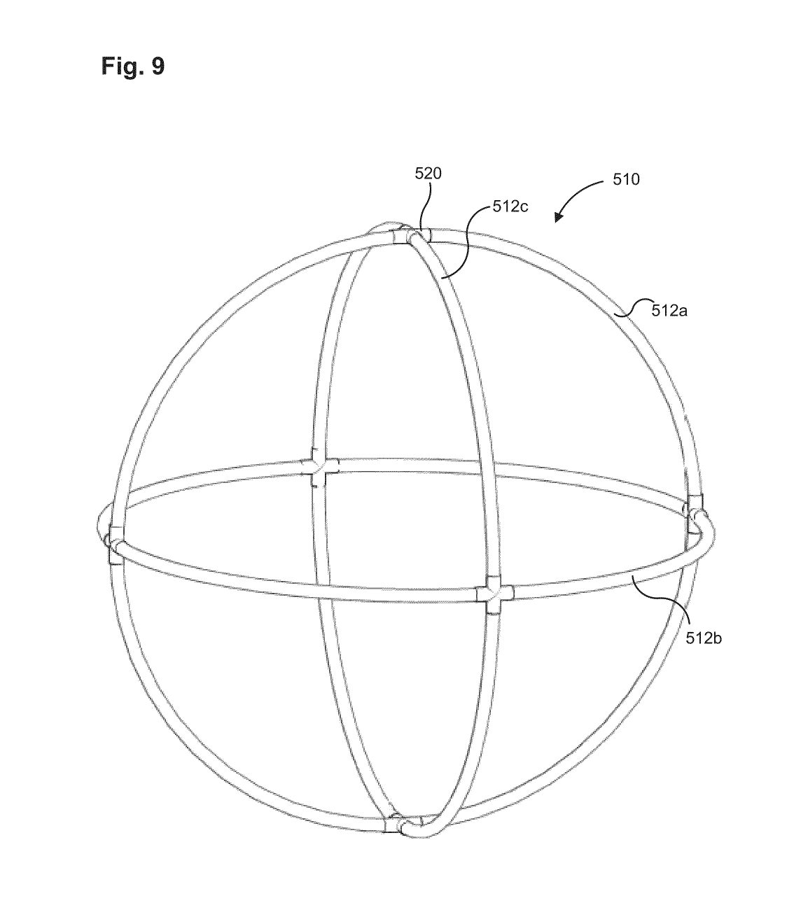

In some embodiments, a support structure for use in an aquaculture containment pen can include support members that have substantially the same diameter or otherwise size. Referring now to FIG. 9, a containment pen for cultivating aquatic organisms includes a support structure 510 having a first support member 512a, a second support member 512b and a third support member 512c (collectively referred to as “the support members 512”) coupled to each other using a plurality of coupling mechanisms 520. Each support member 512 can have substantially the same diameter or otherwise size. In some embodiments, each of the support members 512 (e.g., the support member 512a, 512b and/or 521c) can include a plurality of segments that can be coupled together to form the support members. For example, in some embodiments, each segment of the support members 512 can include an arcuate ring segment (e.g., a ring quadrant) that can be joined at their ends to form a support member 512. In some embodiments, each arcuate ring segment can have a central angle of about 90 degrees. The support members 512 can, for example, be coupled to each other using coupling mechanisms 520 or any other suitable mechanism. In some embodiments, the support members 512 can be coupled to each other at locations that define the vertices of an octahedron.

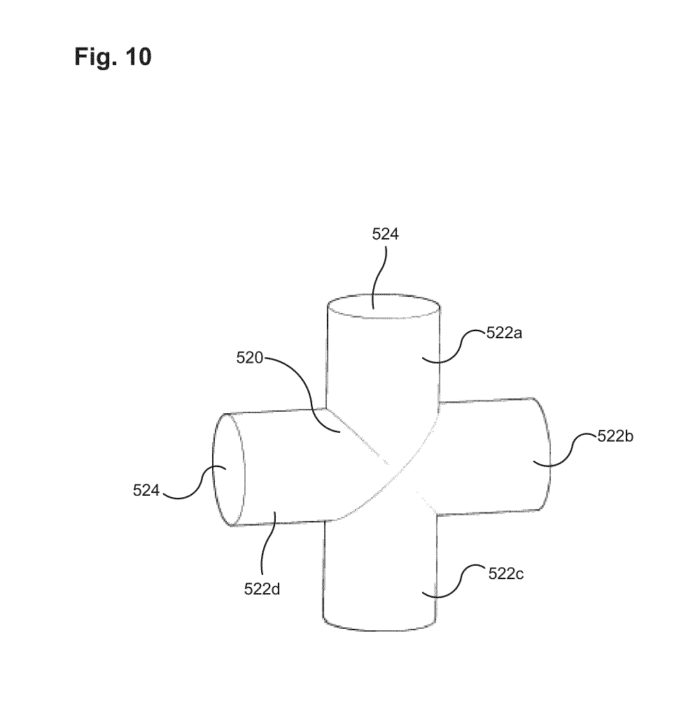

In some embodiments, each of the coupling mechanism 520 shown in FIG. 10, can include a first coupling portion 522a, a second coupling portion 522b, a third coupling portion 522c, and a fourth coupling portion 522d (collectively referred to as “the coupling portions 522”). Each coupling portion 522 defines a cavity 524 configured to removably receive at least a portion of a support member 512, for example, an end of a segment of the support members 512. In some embodiments, the each cavity 524 can include a friction-fit mechanism, snap-fit mechanism, notches, grooves, indents, detents, lock, latch, or any other suitable mechanism, for removably coupling the segments of the support members 512 to the portions 522. In some embodiments, a coupling mechanism can include one or more coupling portions that can allow the segments of the support members 512 to move about an axis (e.g., the X, Y, or Z) axis of the support structure 510. For example, the coupling mechanism can include a plurality of coupling portions (e.g., a first, second, third, and fourth coupling portion) that are swivelly mounted to a central hub via, for example, a pivot mount. In such embodiments, the coupling portions can enable the segments of the support members 512 to pivotally rotate about the pivot mounts, such that the support structure 510 can be moved between an expanded configuration and a collapsed configuration.

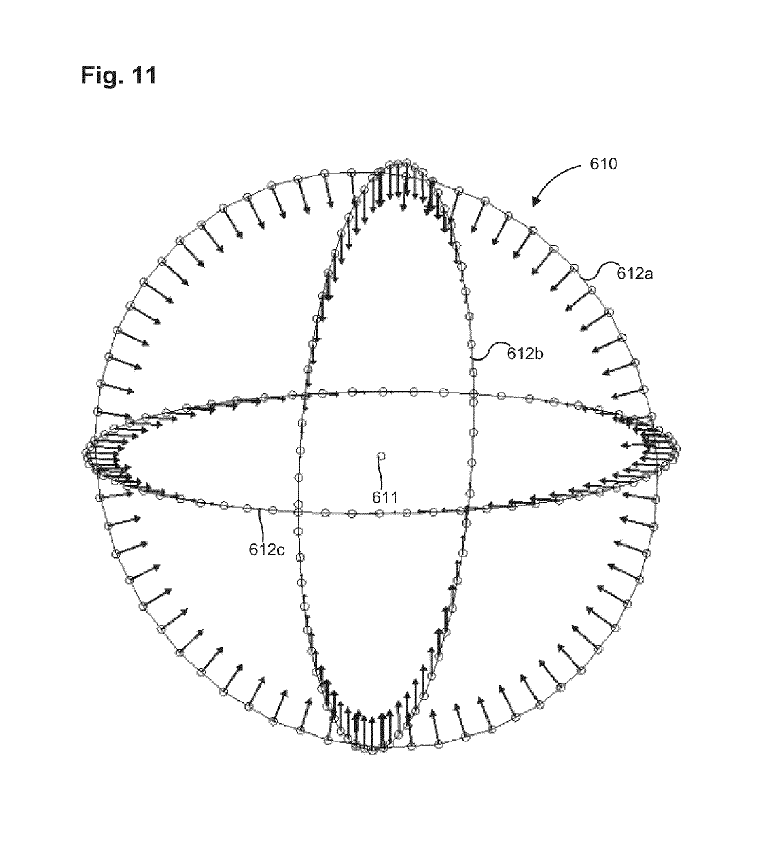

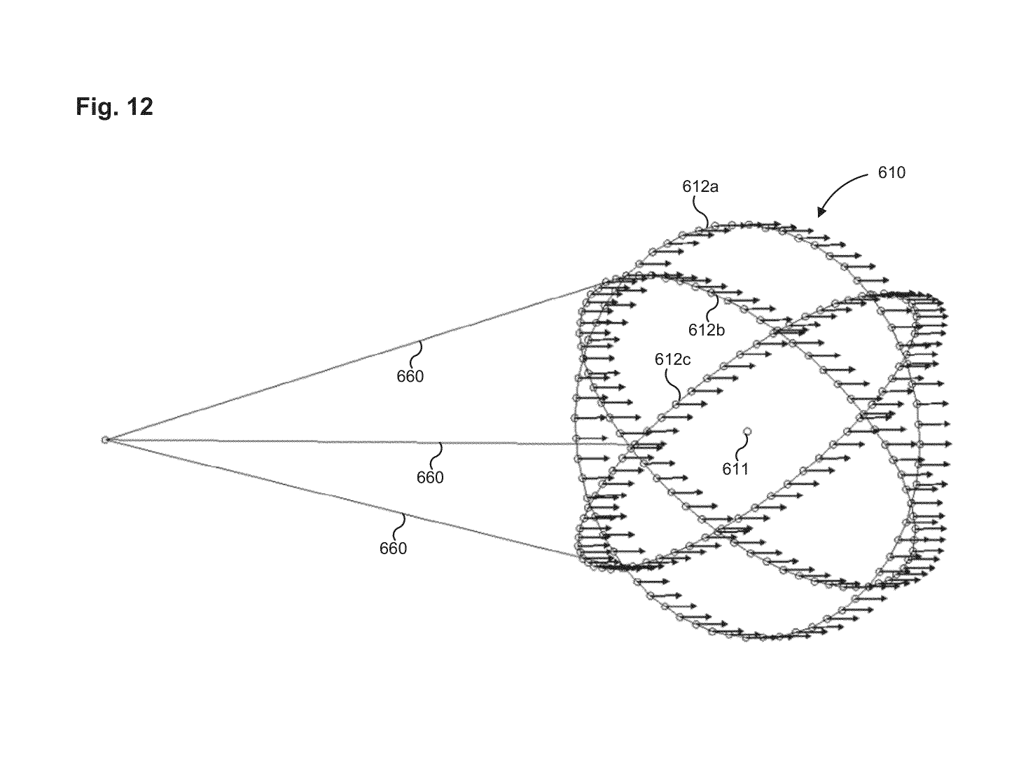

FIG. 11-12 show finite element analysis (FEA) of a model of a support structure 610 of a containment pen according to an embodiment described herein. The support structure 610 of the containment pen was modeled using 2-node beam elements, for a total of 378 nodes and 384 elements. The support structure 610 includes three tubular HDPE support members, 612a, 612b, and 612c (collectively referred to as “the support members 612”). Each support member 612 located in a plane orthogonal to the plane of the other support members 612. Each support member 612 is hollow and has a diameter of 31.8 meters, a cross-sectional diameter of 0.40 m (16 inches) and a wall thickness of 0.04 m (1.5 inches).

As shown in FIG. 11, a 500 lb force was applied between the center of the sphere 611 defined by the support structure 610, and at equally spaced locations along the circumference of each of the support member 612, to simulate the tensile force applied by tensioning members on the support structure 610 as described herein. The resultant axial stress and axial strain results and the non-axial stress and non-axial strain results are summarized below in Table 1

TABLE 1

| | |
|---|---|
| Max Axial Strain | −3.87 × 10⁻⁴ |
| Max Axial Stress (Pa) | −2.58 × 10⁵ |
| Axial Yield Stress (Pa) | 2.42 × 10⁷ |
| Max Non-Axial Strain | 2.42 × 10⁻⁵ |
| Max Non-Axial Stress (Pa) | 5.72 × 10³ |
| Non-Axial Yield Stress (Pa) | 2.42 × 10⁷ |

One inch diameter lines 660 at 15 degree angles were also added to the support structure 610 model described above and shown in FIG. 12 such that the line was coupled to the support structure 610 at three locations to simulate a four point mooring. A series of drag loads associated with current velocities of 0.2 m/s, 0.6 m/s and 1 m/s were applied on the support structure 610. The resultant axial and non-axial stress and strains experienced by the support structure 610 on application of drag loads are summarized in Table 2.

TABLE 2

| | Current Velocity | | |
|---|---|---|---|
| Stress/Strain | 0.2 m/s | 0.6 m/s | 1 m/s |
| Max. Axial Strain | 7.5 × 10⁻⁶ | 1.6 × 10⁻⁴ | 4.72 × 10⁻⁴ |
| Max Axial Stress (Pa) | 5.01 × 10³ | 1.07 × 10⁵ | 3.15 × 10⁵ |
| Axial Yield Stress (Pa) | 2.42 × 10⁷ | 2.42 × 10⁷ | 2.42 × 10⁷ |
| Max. Non-Axial Strain | 1.39 × 10⁻⁵ | 1.64 × 10⁻⁴ | 4.58 × 10⁻⁴ |
| Max. Non-Axial Stress (Pa) | 3.28 × 10³ | 3.88 × 10⁴ | 1.06 × 10⁵ |
| Non-Axial Yield Stress (Pa) | 2.42 × 10⁷ | 2.42 × 10⁷ | 2.42 × 10⁷ |

No deformation of the support structure 610 is observed for any of the drag loads applied on the support structure 610 indicting that the support structure 610 of the containment pen is rigid and capable of withstanding the typical drag loads experienced at offshore aquaculture locations.

While various embodiments of the system, methods and devices have been described above, it should be understood that they have been presented by way of example only, and not limitation. Where methods and steps described above indicate certain events occurring in certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

For example, although various embodiments have been described as having particular features and/or combination of components, other embodiments are possible having any combination or sub-combination of any features and/or components from any of the embodiments described herein. For example, although some embodiments were described as having tensioning members intersecting to form polygons, in some embodiments, the tensioning members might not intersect, for example, the tensioning members can be disposed in the containment net parallel to each other. In some embodiments, the tensioning members can intersect to form polygons that are square, or rectangles. In addition, the specific configurations of the various components can also be varied. For example, the size and specific shape of the various components can be different than the embodiments shown, while still providing the functions as described herein.

1. An apparatus, comprising:
a support structure defining an interior region, the support structure including a first support member disposed in a first plane, a second support member disposed in a second plane, the second plane orthogonal to the first plane, and a third support member disposed in a third plane, the third plane orthogonal to the first plane and the second plane;
a mesh material disposed in the interior region and coupleable to the support structure, the mesh material configured to define a containment volume suitable for cultivating aquatic organisms; and
a plurality of tensioning members configured and disposed to couple the mesh material to the support structure, each of the plurality of tensioning members coupled to the mesh material and at least one of the first support member, the second support member, and the third support member,
the plurality of tensioning members configured to provide tensile loading on the first, second and third support members.

2. The apparatus of claim 1, wherein the first, second and third support members are rings.

3. The apparatus of claim 1, wherein the support structure is a spherical octahedron.

4.-7. (canceled)

8. The apparatus of claim 1, wherein the support structure is configured to have substantially neutral buoyancy.

9.-13. (canceled)

14. The apparatus of claim 1, wherein the containment volume is substantially spherical.

15.-17. (canceled)

18. That apparatus of claim 1, wherein the tensioning members urge the mesh materials into the shape of a geodesic structure.

19. (canceled)

20. The apparatus of claim 1, wherein the tensioning members are configured to exert compression on the support structure, the combination of tension in the tensioning members and compression in the support structure configured to provide structural integrity to the apparatus.

21.-25. (canceled)

26. The apparatus of claim 1, wherein the support structure is configured to be coupleable to a four-point mooring.

27. (canceled)

28. An aquaculture containment pen, comprising:
a support structure including a first ring member, a second ring member and a third ring member, each of the first, second and third ring members configured and disposed substantially orthogonal to the other two ring members;
a containment net coupled to the support structure, the containment net configured and disposed to define a containment volume suitable for cultivating aquatic organisms, the containment net including a plurality of members configured and disposed to couple the containment net to the support structure and provide tensile loading on the first, second and third ring members.

29. The containment pen of claim 28, wherein the first ring member is movably coupled to the second ring member.

30. The containment pen of claim 28, wherein the first and second ring members are movable between a first configuration in which the first and second ring members are substantially coplanar, and a second configuration in which the first and second ring members are substantially orthogonal to each other.

31. The containment pen of claim 29, wherein the second ring member is movably coupled to the third ring member.

32. The containment pen of claim 31, wherein the second and third ring members are movable between a first configuration in which the second and third ring members are substantially coplanar, and a second configuration in which the second and third ring members are substantially orthogonal to each other.

33. The containment pen of claim 28, wherein the first, second and third ring members are coupled to each other at locations defined as the vertices of an octahedron.

34.-36. (canceled)

37. An aquaculture containment pen, comprising:
a support structure including a first ring member movably coupled to a second ring member, and a third ring member movably coupled to the second ring member,
the support structure movable between a first configuration such that the first, second and third ring members are substantially coplanar, and a second configuration such that each of the first, second and third ring members are substantially orthogonal to the other two ring members; and
a containment net coupled to the support structure, the containment net configured and disposed to define a containment volume suitable for cultivating aquatic organisms.

38. The containment pen of claim 37, wherein the containment net includes a plurality of tensioning member configured and disposed to couple the containment net to the support structure and provide tensile loading on the first, second and third ring members in the second configuration.

39.-41. (canceled)

42. The containment pen of claim 37, wherein the containment net is inscribed in the support structure.

43. (canceled)

44. The containment pen of claim 37, further comprising a coupling mechanism configured to movably couple the first ring member to the second ring member.

45. The containment pen of claim 44, wherein the coupling mechanism is a first coupling mechanism, the containment pen further comprising:
a second coupling mechanism configured to couple the second ring member to the third ring member.

46. The containment pen of claim 37, wherein the first ring member has a first diameter and the second ring member has a second diameter, the second diameter less than the first diameter.

47. (canceled)
